(19) United States
(12) Patent Application Publication
(10) Pub. No.: US 2002/0149127 A1
(43) Pub. Date: Oct. 17, 2002

(54) Plug for and method of patching a hole in a wall

(76) Inventor: Walter H. Prior, Newport Beach, CA (US)

Correspondence Address: KLEIN, O'NEILL & SINGH, 2 PARK PLAZA, SUITE 510, IRVINE, CA, 92614, US

(21) Appl. No.: 09/835,895

(22) Filed: Apr. 16, 2001

(51) Int. Cl. B29C 73/06

(52) U.S. Cl. 264/36.2

(57) ABSTRACT

A hole in a wall is easily and quickly repaired by use of a specifically formed plug. The plug is used to draw an outline around the hole. The outline is then cut out to form an opening. The plug is inserted into the opening until an outer surface of the plug is slightly indented or moved inwardly from a front surface of the wall. The outer surface of the plug and the opening are then covered or plastered over. If needed, the surface formed on the indented covered plug and the opening are sanded and painted.

### BACKGROUND OF THE INVENTION

1. Field of the Invention

This invention relates generally to wall repair and, more particularly, to a plug for and method of repairing a damaged wall.

2. Description of Related Art

As is well known, if a door or other object is banged or slammed into a wall, particularly one made out of sheet rock, an ugly depression or hole will be made. To repair such depressions or holes, depending on their size, persons try to use plaster, and if large, also use some type of netting or sheeting in an attempt to hold the plaster in place. The patched or repaired hole must then be sanded and painted, and if too rough, causes many further problems.

However, the known methods and products for repairing holes in walls do not always produce acceptable or attractive results. Therefore, there exists a need in the art for an improved product and method for repairing holes in walls in an acceptable and attractive manner.

### SUMMARY OF THE INVENTION

It is, therefore, a general object of the present invention to provide an improved and simplified method of repairing walls. It is a particular object of the present invention to provide an improved method to more easily, quickly and smoothly patch a hole in a wall. It is another particular object of the present invention to provide an improved plug for use in patching holes in walls. It is yet another particular object of the present invention to provide an improved method of patching holes in walls that enables a person to easily and quickly provide a smooth patch. And, it is still another particular object of the present invention to provide an improved method that allows a person to quickly cut out a portion of a wall, insert a plug and plaster over the plug and any remaining opening.

These and other objects and advantages of the present invention are achieved by providing a plug that is used to outline an area, trimming around the area, inserting the plug in the trimmed out area and plastering over the plug in the trimmed out area.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a front elevational view showing a person forming an outline around a hole in a wall;

FIG. 2 is a front elevational view of a person cutting out the outlined portion of FIG. 1;

FIG. 3 is a perspective view of the plug being inserted in the cut-out hole; and;

FIG. 4 is a front elevational view of the cut-out hole with the plug held therein, and a person plastering over the plug.

### DETAILED DESCRIPTION OF THE PREFERRED EMBODIMENTS

The following description is provided to enable any person skilled in the art to make and use the invention, and sets forth the best modes contemplated by the inventor of carrying out his invention. Various modifications, however, will remain readily apparent to those skilled in the art, since the generic principles of the present invention have been defined herein, specifically to provide for an improved and simplified method and article for use in easily and quickly repairing a hole in a wall.

Basically, the present invention incorporates a block or plug of material that is placed in an opening made in a wall and then has plaster applied over the end of the plug and the opening. The plastered hole is then sandpapered smooth and painted to provide an attractive repair.

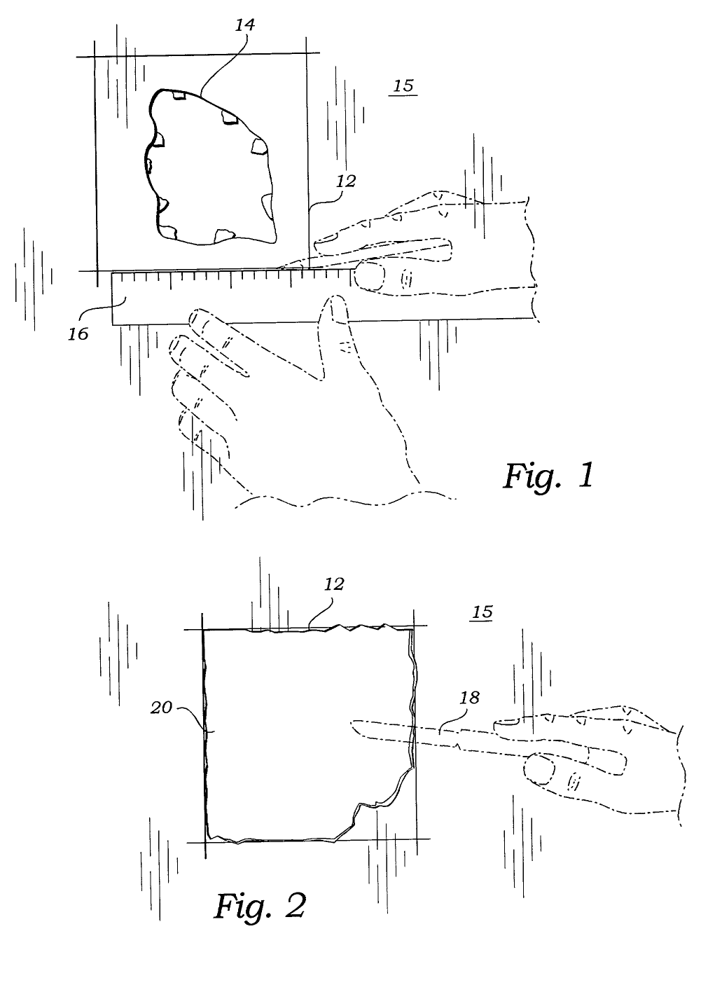

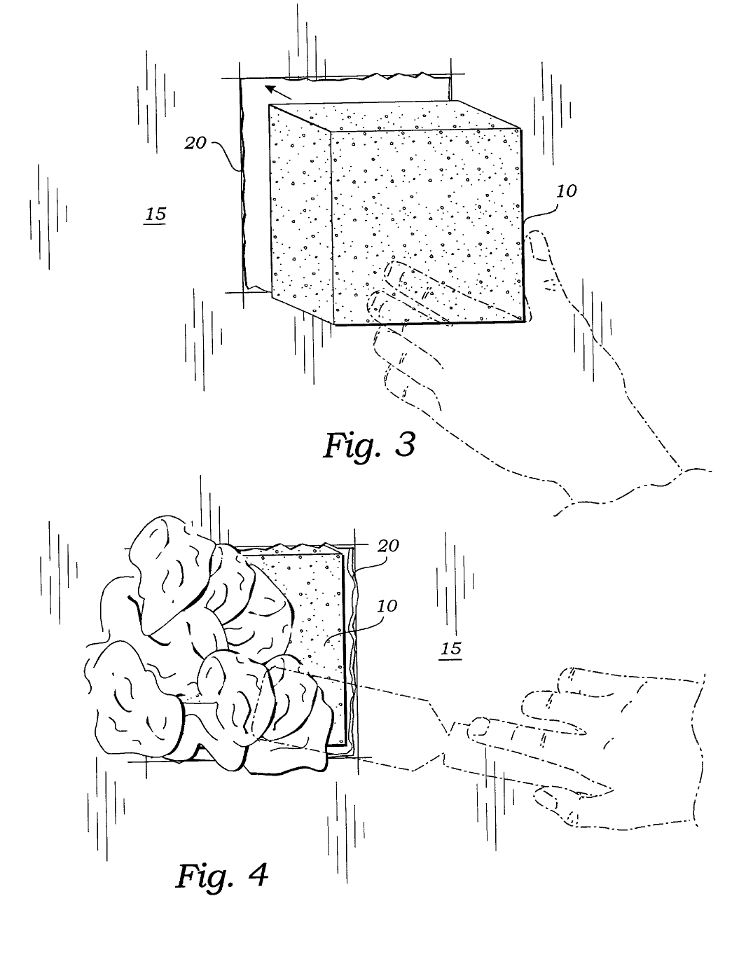

Turning now to the drawings, FIGS. 1-4 illustrate the preferred method using a block or plug of material 10 (see FIGS. 3 and 4), preferably made from a lightweight plastic or foam material, such as Styrofoam or the like. The plug 10 may be any desired size, and is preferably rectangular, as shown. The plug 10 is preferably die cut to exact measurements. In a currently preferred embodiment of the plug 10, a precisely measured die cut block that is a 3 ⅞″ cube is used.

As shown in FIG. 1, the die cut block 10 is used to draw an outline 12 around a hole 14 in a wall 15 that is to be. The outline 12 may be straightened or darkened as needed by using a ruler or other straight edge 16.

As illustrated in FIG. 2, the outlined area 2 is then cut or trimmed out, as by use of a knife, or the like 18, until a substantially rectangular or square opening 20 is formed.

The rectangular plug 10 is then inserted in the opening 20 (see FIG. 3), until a back surface of the plug contacts an inner wall, not shown, with the front surface of the plug, misaligned with or slightly indented from the outer surface of the wall 15 (approximately ⅛″). That is, a slight indentation is formed in the opening. The plug 10 will be retained in place in the opening 20 (see FIG. 4), and cannot (or should not) fall into the space behind wall 15.

As shown in FIG. 4, with the plug 10 held in the opening 20, and the front face of the plug moved in from or misaligned with the front surface of wall 15, the opening 20 and the indentation formed by the front surface of the plug are plastered or otherwise covered or filled. The material covering, filling or plastered over opening 20 and the front surface of the plug 10 is then sandpapered to the desired smoothness, and the smooth surface painted to match the remainder of the front surface of the wall 15, in an attractive and expeditious manner.

It, therefore, can be seen that the method and plug of the present invention allow a hole in a wall to be easily, quickly and smoothly repaired in a minimum period of time, with a minimum of effort. Additionally, the repair made will provide a more attractive appearance.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for repairing a hole in a wall comprising:
forming an outline around a hole to be repaired in a wall;
cutting out an opening using the outline as a form;
inserting a plug into the opening; and
plastering over the plug in the opening to repair the hole.

2. The method of claim 1 wherein the outline is formed by drawing around the plug.

3. The method of claim 2 wherein the outline is rectangular.

4. The method of claim 3 wherein the plug is a cube.

5. The method of claim 4 wherein the cube is approximately 3 ⅞″ on a side.

6. The method of claim 5 wherein an indented surface formed by an outer surface of the plug in the opening is plastered over, sandpapered smooth and then painted.

7. The method of claim 1 wherein an indented surface formed by an outer surface of the plug in the opening is plastered over, sandpapered smooth and painted to match the wall.

8. The method of claim 7 wherein the plug is rectangular and the outline is formed by drawing around one end of the plug.

9. The method of claim 8 wherein the plug is a cube that is approximately 3 ⅞″ on a side.

10. A method for repairing a hole in a wall comprising the steps of:
using a rectangular-shaped plug to draw an outline around a hole in a wall to be repaired;
cutting along the outline to form a rectangular opening in the wall;
inserting the rectangular-shaped plug into the opening until an outer surface of the rectangular-shaped plug is slightly indented from a front surface of the wall; and
covering the indented outer surface of the rectangular-shaped plug in the rectangular opening with plaster, or the like.

11. The method of claim 10 wherein the plug is a cube that is approximately 3 ⅞″ on a side.

12. The method of claim 11 wherein a surface formed by the covered indented outer surface of the rectangular-shaped plug in the rectangular opening is sandpapered smooth and then painted to match the wall.

13. A method for repairing a hole in a wall, comprising the steps of:
forming a precisely die-cut cube to use as a plug;
using the die-cut cube to draw an outline around a hole in a wall to be repaired;
cutting along the outline to form a rectangular opening in the wall;
inserting the die-cut cube into the rectangular opening until it meets an inner wall, behind the wall with a front face of the die-cut cube slightly misaligned from the front surface of the wall; and
covering the misaligned front surface of the die-cut cube held in the rectangular opening with plaster, or the like, to thereby repair the hole.

14. The method of claim 13 wherein a surface formed by the covered slightly misaligned outer surface of the rectangular-shaped plug in the rectangular opening is sandpapered smooth and then painted to match the wall.
